(19) United States
(12) Patent Application Publication
(10) Pub. No.: US 2002/0116490 A1
(43) Pub. Date: Aug. 22, 2002

(54) Method for monitoring a network as the network changes in size

(76) Inventors: Iain Hogg, Edinburgh (GB); Christopher Robert Linzell, St. Albans (GB); David James Stevenson, Edinburgh (GB); Ronan Francois Daniel Grandin, Edinburgh (GB)

Correspondence Address: McDonnell Boehnen Hulbert & Berghoff, 32nd Floor, 300 S. Wacker Drive, Chicago, IL, 60606, US

(21) Appl. No.: 09/873,898

(22) Filed: Jun. 5, 2001

(30) Foreign Application Priority Data
Feb. 16, 2001 (GB) 0103868.6

(51) Int. Cl. G06F 15/173

(52) U.S. Cl. 709/224; 709/223

(57) ABSTRACT

A method of monitoring a network of devices comprising defining at least two types of device, and monitoring the different types of device using different monitoring procedures, either interrogating said devices at different intervals or interrogating said devices using different protocols .The defined types of device comprise core devices and edge devices. The method also comprises determining the number of devices in the network to be monitored, and changing the monitoring intervals for each type of device in accordance with the determined number.

### BACKGROUND OF THE INVENTION

The present invention relates to a method for monitoring a network as the network changes in size that is as the number of devices in the network increases or decreases.

Thus the present invention relates to the process of discovery of devices on a network, that is, a network of electronic devices comprising, for example, work stations, personal computers, servers, hubs, routers, bridges, switches, (hereinafter collectively referred to as devices of the network). The network may be a local area network (LAN) such as an Ethernet network, wide area network (WAN) or other types including wireless networks and may operate in accordance with any desired protocol.

Monitoring of the network will normally be carried out by a network manager, the network manager being able to determine traffic on the network, and being able to determine problems or faults in the network with the devices or links between devices.

As a network increases in size as further links and devices are added to it, the volume of network traffic will typically increase, and monitoring the number of devices becomes increasingly more difficult.

In order to manage the process, it is necessary to take into account the size of the network. In prior arrangements, this involves reducing the number of devices which are monitored so as not to overwhelm the monitoring system, by imposing an arbitrary limit on the number of devices monitored. As an alternative, monitoring stations have been spread through the network with the network manager collating the aggregated responses.

### SUMMARY OF THE INVENTION

The present invention provides a method for monitoring a network as the network changes in size to enable the monitoring process to be maintained under control.

According to a first aspect, the invention comprises a method of monitoring a network of devices comprising the step of defining at least two types of device, and monitoring the different types of device in different ways.

The method may define as types of device devices which require different levels (e.g. frequency) or different types (e.g. SNMP, TCMP) of monitoring and for example may define as different types of device core devices and edge devices, or may be defined by the number of other devices connected to the relevant device. Thus core devices will be connected to more devices than edge devices which edge devices will generally only be connected to one other device. Clearly the more devices a particular device is connected to, the more important it is to regularly monitor that device.

According to a second aspect, the present invention provides a method of monitoring a network comprising the steps of determining the number of devices in the network to be monitored, and changing the monitoring procedure in accordance with the determined number.

The method includes the step of polling the devices in the network and the step of changing the monitoring procedure comprised reducing the frequency of polling of devices as the determined number increases.

The method includes monitoring the devices using one or more different protocols (for example, SNMP, and TCMP) and the step of changing the monitoring procedure comprises changing the protocol used to monitor devices as the determined number changes.

Whilst the monitoring procedure could be changed for each additional deletion of device from the network, in a preferred arrangement, the method includes the step of providing one or more ranges of numbers, and determining which range the determined number falls into, and changing the monitoring procedure in accordance with the range of numbers in which the determined number falls.

In a preferred arrangement, the devices are divided into type (for example core devices, edge devices, routers) and different types of devices are monitored using different monitoring procedures. For example, core devices will be monitored more frequently than edge devices.

In a preferred arrangement, the step of determining the number of devices is initiated when a monitored device is added or removed from the network.

According to another aspect of the invention, the invention comprises a computer program, or a computer program on a computer readable medium loadable into a digital computer, or embodied in a carrier wave, said computer program operating in accordance with the method set out above.

According to another aspect, the invention comprises a computer network comprising a plurality of devices, including means for defining at least two types of device, and a monitor for monitoring the different types of device using different monitoring procedures.

Preferably, said monitor is adapted to interrogate said different types of device at different intervals.

Preferably, said monitor is adapted to interrogate said different types of devices using different protocols.

Preferably, said different types of device comprise core devices and edge devices.

Preferably, said different types of device are defined in terms of the number of other devices a particular device is connected to

According to a yet further aspect of the invention, there is provided a computer network comprising a monitor for monitoring the network said monitor including means for determining the number of devices in the network to be monitored, and means for changing the monitoring procedure in accordance with the determined number.

Preferably, the monitor is adapted for interrogating the devices in the network and the means for changing the monitoring procedure comprises means for changing the frequency of interrogation of devices as the determined number changes.

Preferably, the monitor is adapted for interrogating the devices using a protocol and the means for changing the monitoring procedure comprises means for changing the protocol used to monitor devices as the determined number changes.

Preferably, there is provided one or more ranges of numbers, and means for determining which range the determined number falls into, and the means for changing the monitoring procedure is adapted to change the monitoring procedure in accordance with the range of numbers in which the determined number falls.

### BRIEF DESCRIPTION OF THE DRAWINGS

A preferred embodiment of the invention will now be described by way of example only and with reference to the accompanying drawings in which:

FIG. 1 is a diagrammatic view of a network incorporating a preferred embodiment of the invention, and

FIG. 2 is a flowchart of the method of the invention

### DESCRIPTION OF THE PREFERRED EMBODIMENTS

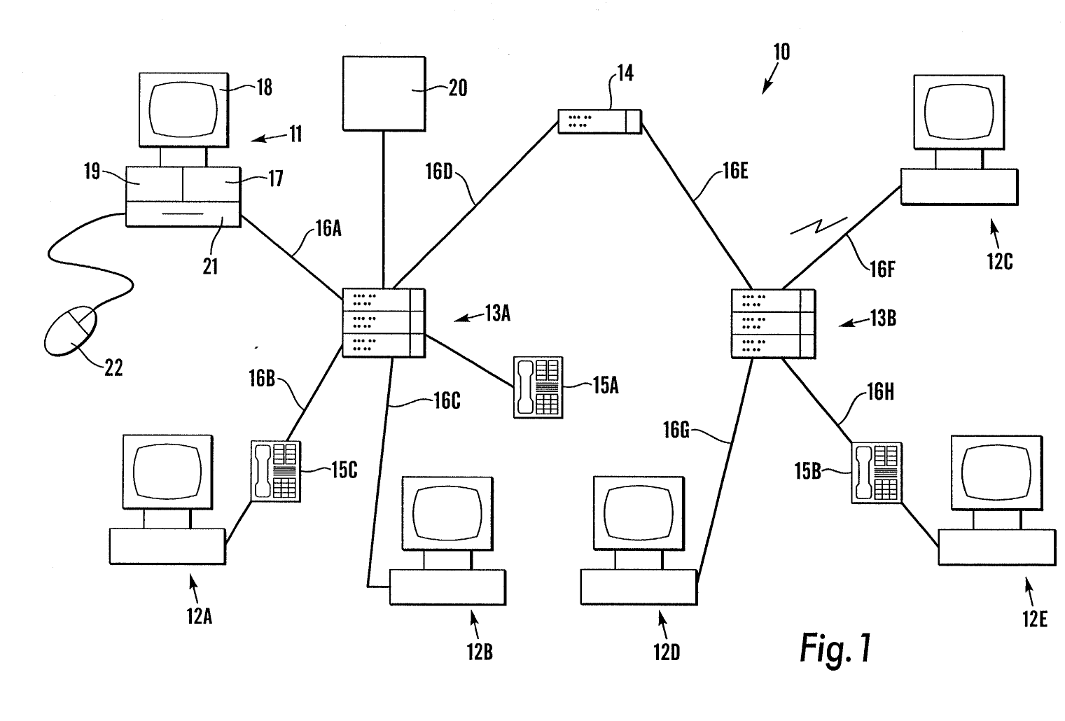

Referring to FIG. 1 there is shown a physical network 10 comprising a plurality of devices in the form of a network supervisor's workstation or computer 11, other workstations 12B-E, hubs 13A, 13B, switch 14. The network is a simple network and is set out for purposes of illustration only. Other configurations and arrangements may be used.

The devices are connected together by means of links 16A-H which may be hard wired and utilise any desired protocol, and link 16F which is a wireless link.

The network supervisor's workstation includes, in addition to a visual display unit 18, a central processing unit or signal processor 19, a selector which may be in the form of a mouse 22, a program store 21 which may comprise, for example, a CD drive, a floppy disk drive or a zip drive, and a memory 17 for storing a program which may have been loaded from the program store 21 or downloaded for example via Internet from a website.

To discover the network, using a protocol such as SNMP, the network supervisor's computer 11 interrogates each device at regular intervals, and analyses the network, and stores in the memory 17 the information relating to the type of each device within the network, the number of devices, and the links between the devices. In essence, many devices include a so-called agent which stores information about the device such as its unique MAC address, its SNMP sysObjectId (which identifies what the device is), what model type it is, how many ports it has and how they are connected, and the MAC address of the origin of the data which at least some of the ports have received and hence to which they are directly or indirectly connected. The computer 11 interrogates the agents of each device to obtain the said information.

In a preferred arrangement, the computer 11 may, on command from the selector 22, process signals from the memory 17 by the signal processor 19 and provide on the visual display unit 18 a network map showing each of the devices and the links therebetween.

In the examples shown, the network is simple but of course in many instances the network will be considerably more complex.

As set out above, the supervisor's computer 11 interrogates each device and establishes information relating to the type of the device, that is, whether it is a core device or an edge device, and how many other devices it is connected to. By edge device, we mean a device which is on the edge of the network, that is, it is connected to only a single other device. By core devices, we mean devices which are connected to more than one other device. Optionally, different types of core device can be defined, that is, a series of types of core device may be defined in terms of the number of devices they are connected to. Thus there may be core device type A which is connected to two other devices, core device type B which is connected to three other devices, etc.

As will be understood, the network supervisor will wish to supervise, for example, the traffic and faults on the network and as the size of the network increases over time, that is, further devices are added to the network, then the amount of calculation required to monitor the network increases at a rapid rate. Furthermore, as the size of the network increases, the amount of network traffic generated by the interrogation of the devices by the computer 11 increases.

In order to cope with larger networks, it is necessary to reduce the amount of work required to be carried out by the network computer 11 in the monitoring application and to cut down the amount of traffic sent across the network to the network supervisor's computer 11 in the monitoring role. As set out above, earlier solutions to this problem have involved imposing a limit on the number of devices which the computer 11 will monitor. However this means losing visibility of part of the network. Alternatively, in the past, monitoring stations have been spread through the network, each monitoring station monitoring a section of the network, and aggregated information is passed to the network supervisor's computer 11. While this localises network traffic and alleviates the demand on the computer 11, it involves increased complexity and cost.

One embodiment of the invention reduces or overcomes these problems by changing the regular intervals at which each device is interrogated by the computer 11 depending upon the number of devices. In essence, as the number of devices on the network increases, the intervals at which each device is interrogated are increased.

Whilst it is possible to increase the interrogation interval in small steps as each further device is added to the network, (or vice versa, reduce the intervals as network devices are removed) it is preferred to provide a range of numbers of devices, and for numbers of devices in each range, provide interrogation at a relevant interval. In a typical example we provide three ranges of numbers, the first range being from 0-99 monitored devices, the second range 100-199 monitored devices, and the third range 200+monitored devices.

The devices will be interrogated at different intervals depending as to whether the number of devices is in the first, second or third range. As an example, if the number of monitored devices is in the first range, 0-99, then the devices may be interrogated at 30 second intervals, if the number of monitored devices is in the second range, that is, 100-199 devices, then the devices may be interrogated at 60 second intervals, and if the number of monitored devices is in the third range, 200+devices, then the devices may be interrogated at 90 second intervals.

In addition, as set out above, different types of device may be monitored at different intervals. For example, core devices (i.e. monitored devices coupled to at least two other devices) should be interrogated at more frequent intervals than edge devices (i.e. monitored devices only coupled to one other device). Thus in a preferred arrangement the interrogation intervals may be as follows:

for 0-99 devices (first range) in network, for core devices interrogation interval 30 seconds

for 100-199 devices (second range) in network, for core devices interrogation interval 60 seconds

for 200+devices (third range) in network, for core devices interrogation interval 90 seconds

for 0-99 devices (first range) in network, for edge devices interrogation interval 60 seconds

for 100-199 devices (first range) in network, for edge devices interrogation interval 120 seconds

for 200+devices (first range) in network, for edge devices interrogation interval 240 seconds.

Thus whenever a device is added to or removed from the network, at the next interrogation the computer 11 checks the number of devices to see if the total number of devices has entered a new range. If the number has entered a new range, then a new range of interrogation intervals will be used. The interrogation intervals for the devices of each type will be modified.

The advantage of the method of the invention is that the monitoring operation can be scaled to a large network whilst maintaining monitoring of all devices on the network and a higher level of monitoring of the more important devices such as the core devices.

In the above description, the interrogation interval depends upon both the number of devices in the network and the type of device being interrogated. Instead of, or in addition to changing the interrogation interval, different types of protocol may be used to interrogate each device, the protocol chosen depending on the number of devices and the type of device. Thus for core devices in relatively small networks a more complex protocol which provides more information (for example SNMP) may be used, and for less important devices such as edge devices, or in larger networks, a protocol which provides less information, (for example TCMP) may be used. This will reduce the network traffic caused by the interrogation.

We have described how the network is supervised. The preferred method of the invention is carried out under the control of the network supervisor's workstation or computer 11 and in particular by means of a program controlling the processor apparatus of that computer or elsewhere in the system.

The program for controlling the operation of the invention may be provided on a computer readable medium, such as a CD, or a floppy disk, or a zip drive disk carrying the program or equivalent, or may be provided on a computer or computer memory carrying the website of, for example, the supply of the network products. The program may be downloaded from whichever appropriate source and used to control the process or to carry out the steps of the invention as described.

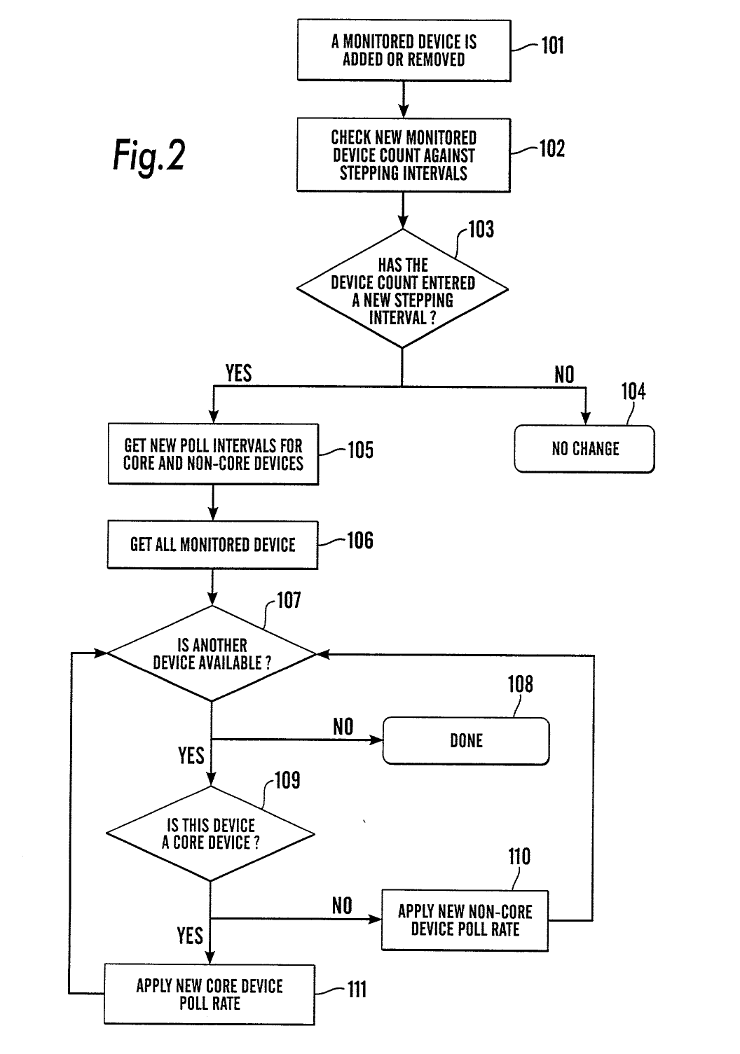

FIG. 2 shows a flowchart of a preferred embodiment of the process of the invention corresponding to the program. For simplicity, it only includes two types of device, core devices and edge devices.

The program may include:

program step 101, detect that a monitored device is added or removed;

program step 102, check number of devices detected against ranges of numbers;

program step 103, has the number of devices entered a different range of numbers?

if no, go to program step 104, no change

if yes, go to program step 105, get new time intervals for core and edge devices;

program step 106, get all monitored devices;

program step 107, is another device available?

if no, go to step 108, finish;

if yes, go to program step 109, is the device a core device?

if no, go to program step 110, apply new edge device interrogation interval and return to program step 107;

if yes, go to program step 111, apply new core device interrogation interval and go to step 107.

The invention is not restricted to the details of the foregoing example.

1. A method of monitoring a network of devices comprising the step of defining at least two types of device, and monitoring the different types of device using different monitoring procedures.

2. A method as claimed in claim 1 in which said different monitoring procedures comprise interrogating said devices at different intervals.

3. A method as claimed in claim 1 in which said different monitoring procedures comprise interrogating said devices using different protocols.

4. A method as claimed in claim 1 in which said defined types of device comprise core devices and edge devices.

5. A method as claimed in claim 1 in which said defined types of device are defined in terms of the number of other devices a particular device is connected to.

6. A method of monitoring a network comprising the steps of determining the number of devices in the network to be monitored, and changing the monitoring procedure in accordance with the determined number.

7. A method as claimed in claim 6 in which the monitoring procedure includes interrogating the devices in the network and the step of changing the monitoring procedure comprises changing the frequency of interrogation of devices as the determined number changes.

8. A method as claimed in claim 6 in which the monitoring procedure includes interrogating the devices using a protocol and the step of changing the monitoring procedure comprises changing the protocol used to monitor devices as the determined number changes.

9. A method as claimed in claim 6 including the step of providing one or more ranges of numbers, and determining which range the determined number falls into, and changing the monitoring procedure in accordance with the range of numbers in which the determined number falls.

10. A method as claimed in claim 6 including the step of dividing the devices into types and monitoring the different types of devices using different monitoring procedures.

11. A method as claimed in claim 1 in which said defined types of device comprise core devices and edge devices.

12. A method as claimed in claim 1 in which said defined types of device are defined in terms of the number of other devices a particular device is connected to.

13. A method as claimed in claim 6 in which the step of determining the number of devices is initiated when a monitored device is added or removed from the network.

14. A computer program, or a computer program on a computer readable medium loadable into a digital computer, or embodied in a carrier wave, said computer program operating in accordance with the method as claimed in claim 1.

15. A computer program, or a computer program on a computer readable medium loadable into a digital computer, or embodied in a carrier wave, said computer program being adapted for monitoring a network of devices including first and second types of device, said computer program comprising the following steps;
a first program step to detect that a monitored device is added or removed;
a second program step to check the number of devices detected against ranges of numbers;
a third program step to determine if the number of devices has entered a different range of numbers;
a fourth program step in which if it is determined that the number of devices has not entered a new range, then no change is made to the interrogation interval;
a fifth program step in which if it is determined that the number of devices has entered a new range, then get new interrogation time intervals for said first and second types of devices;
a sixth program step to get all monitored devices;
a seventh program step to determine if another device is available;
an eighth program step in which if it is determined that another device is not available then finish;
a ninth program step in which if it is determined that another device is available then determine if it is a first type of device;
a tenth program step in which if it is determined that the device is a first type of device then apply a first interrogation time interval and return to the seventh program step;
an eleventh program step in which if it is determined that the device is a second type of device then apply a second interrogation time interval and return to the seventh program step.

16. A computer network comprising a plurality of devices, said computer network including means for defining at least two types of device, and a monitor adapted to monitor the different types of device using different monitoring procedures.

17. A computer network as claimed in claim 17 in which said monitor is adapted to interrogate said different types of device at different time intervals.

18. A computer network as claimed in claim 17 in which said monitor is adapted to interrogate said different types of devices using different protocols.

19. A computer network as claimed in claim 16 in which said different types of device comprise core devices and edge devices.

20. A computer network as claimed in claim 16 in which said different types of device are defined in terms of the number of other devices a particular device is connected to

21. A computer network comprising a plurality of devices, said computer network including a monitor for monitoring the network said monitor including means for determining the number of devices in the network to be monitored, and means for changing the monitoring procedure in accordance with the determined number.

22. A computer network as claimed in claim 21 in which the monitor is adapted for interrogating the devices in the network and the means for changing the monitoring procedure comprises means for changing the frequency of interrogation of devices as the determined number changes.

23. A computer network as claimed in claim 21 in which the monitor is adapted for interrogating the devices using a protocol and the means for changing the monitoring procedure comprises means for changing the protocol used to monitor devices as the determined number changes.

24. A computer network as claimed in claim 21 including means for providing one or more ranges of numbers, and means for determining which range the determined number falls into, and the means for changing the monitoring procedure is adapted to change the monitoring procedure in accordance with the range of numbers in which the determined number falls.

25. A computer network as claimed in claim 21 including means for dividing the devices into defined types and the monitor monitors the different types of devices using different monitoring procedures.

26. A computer network as claimed in claim 25 in which said defined types of device comprise core devices and edge devices.

27. A computer network as claimed in claim 21 in which said defined types of device are defined in terms of the number of other devices a particular device is connected to.

28. A computer network as claimed in claim 21 in which the step of determining the number of devices is initiated when a monitored device is added or removed from the network.

29. A computer program, or a computer program on a computer readable medium loadable into a digital computer, or embodied in a carrier wave, said computer program operating in accordance with the method as claimed in claim 6.
